(19) United States
(12) Patent Application Publication
(10) Pub. No.: US 2008/0200165 A1
(43) Pub. Date: Aug. 21, 2008

(54) Mobile communication device employment of cellular service and personal radio service

(76) Inventors: Ranjan Sharma, New Albany, OH (US); Shengqiang Wang, Cary, NC (US)

Correspondence Address: PATTI , HEWITT & AREZINA LLC, ONE NORTH LASALLE STREET, 44TH FLOOR, CHICAGO, IL, 60602, US

(21) Appl. No.: 11/707,405

(22) Filed: Feb. 16, 2007

(51) Int. Cl. H04Q 7/20; H04M 1/00

(52) U.S. Cl. 455/426.1; 455/552.1

(57) ABSTRACT

A mobile communication device of an apparatus in one example is configured for communication through employment of a cellular service and a personal radio service.

### TECHNICAL FIELD

The invention relates generally to wireless communication and more particularly to mobile communication devices.

### BACKGROUND

Mobile phones (including smart phones that combine a phone with a personal digital assistant) may operate over various wireless services, for example, cellular services. Examples of cellular service are code division multiple access (CDMA) service and global system for mobile communications (GSM) service. The cellular services are operated over frequency bands that are regulated or endorsed by an organization or government entity, for example, the Federal Communication Commission (FCC), the European Radiocommunications Office, or European Telecommunications Standards Institute (ETSI). Accordingly, unauthorized communication devices without a license for communication are not allowed to transmit or receive on the regulated frequency bands. A service provider for the cellular service typically charges an end user for communication sessions (e.g., airtime) based on a usage or prepay contract.

An alternate means for mobile communication is hand-held radios and walkie-talkies, which operate in different frequency bands that allow either unlicensed access or reduced license costs. Examples of these frequency bands defined by the FCC are personal radio services (PRS). Some personal radio services require a license grant from the FCC, while others require only that the radio is properly authorized under the FCC's rules.

### SUMMARY

The invention in one implementation encompasses an apparatus. The apparatus comprises a mobile communication device configured for communication through employment of a cellular service and a personal radio service.

Another implementation of the invention encompasses a method. A request for a communication session between a first mobile communication device and a second mobile communication device is received. A determination of a distance between the first mobile communication device and the second mobile communication device is made. A selection is made between a personal radio service (PRS) and a cellular service for the communication session based on the determination of the distance between the first mobile communication device and the second mobile communication device.

### DESCRIPTION OF THE DRAWINGS

Features of example implementations of the invention will become apparent from the description, the claims, and the accompanying drawings in which:

FIG. 1 is a representation of one implementation of an apparatus that comprises one or more mobile communication devices, a cellular service network, and a global positioning system satellite.

FIG. 2 is a representation of one implementation of a predetermined channel table for the apparatus of FIG. 1.

FIG. 3 is a representation of a logic flow for a service control point of the cellular service network of FIG. 1.

### DETAILED DESCRIPTION

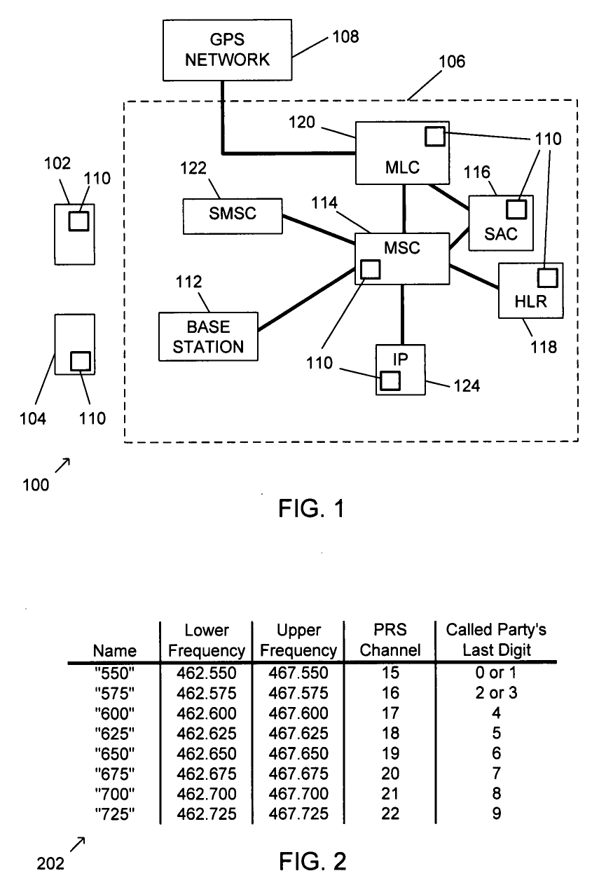

Turning to FIG. 1, an apparatus 100 in one example comprises one or more mobile communication devices 102 and 104, a cellular service network 106, and a global positioning system (GPS) network 108. The mobile communication devices 102 and 104 in one example comprise mobile phones or smart phones that are compatible with a cellular service. Examples of the cellular service comprise a code division multiple access (CDMA) service or a global system for mobile communications (GSM) service. In a further example, the mobile communication devices 102 and 104 are compatible with the GPS network 108 for determination of their respective locations (e.g., “GPS enabled”).

The mobile communication devices 102 and 104 are also compatible with one or more radio frequencies for a personal radio service (PRS). Examples of the PRS comprise family radio service (FRS), general mobile radio service (GMRS), citizens band radio service (CB), and multi-use radio service (MURS) as defined by the Federal Communication Commission (FCC) under 47 C.F.R. part 95. Additional examples of the PRS comprise the Private/Professional Mobile Radio (PMR) and Public Access Mobile Radio (PAMR) as defined by the European Radiocommunications Office. In alternative embodiments, the mobile communication devices 102 and 104 may support additional mobile communication services and/or frequency bands for communication sessions. For example, the mobile communication devices 102 and 104 may support two or more of the PRS, CDMA, GSM, digital enhanced cordless telecommunications (DECT), wideband integrated dispatch enhanced network (WiDEN), personal handyphone system (PHS), and universal mobile telecommunication system (UMTS).

The mobile communication devices 102 and 104 in one example support a “dual-mode” service. The dual-mode service in one example allows the mobile communication devices 102 and 104 to communicate over either the cellular service or an alternate service, such as the PRS. The mobile communication devices 102 and 104 in one example automatically switch to the PRS when the cellular service is not available, for example, in remote geographic areas or with sporadic cellular service coverage, such as in hilly or mountainous areas. In alternative implementations, the PRS may comprise radio frequencies or services that are unregulated, intended for point-to-point or walkie-talkie communication, or intended for short-range, low power radio for personal communications, radio signaling, and business communications, as will be appreciated by those skilled in the art. The mobile communication devices 102 and 104 in one example comprise an instance of a computer-readable signal-bearing medium 110, as described herein.

The cellular service network 106 is configured to provide the cellular service (e.g., CDMA or GSM service) to one or more of the mobile communication devices 102 and 104. The cellular service network 106 in one example comprises a base station 112, a mobile switching center (MSC) 114, a service application component (SAC) 116, a home location register (HLR) 118, a mobile location center (MLC) 120, a short message service center (SMSC) 122, and an intelligent peripheral 124. One or more of the MSC 114, the SAC 116, the HLR 118, and the MLC 120 comprise an instance of a computer-readable signal-bearing medium 110, as described herein.

The present example of the cellular service network 106 corresponds to a non-Internet Protocol Multimedia Subsystem (IMS) network. For example, the SAC 116 comprises a service control point. In an alternative embodiment, the cellular service network 106 comprises an IMS network. In this alternative embodiment, the MSC 114 may be replaced by a serving call session control function (S-CSCF) and the SAC 116 may comprise an application server. Additional components, signals, and/or protocols of the cellular service network 106, for example, Wireless Intelligent Networks (WIN), Customized Applications for Mobile network Enhanced Logic (CAMEL), and Initial Filter Criteria (IFC), may be replaced to support the IMS network or other cellular network standards, as will be appreciated by those skilled in the art.

The base station 112 in one example provides an air interface to the mobile communication devices 102 and 104 for communication with the cellular service network 106. The MSC 114 in one example provides control and routing for communication sessions originated from and terminated to the mobile communication devices 102 and 104. The SAC 116 in one example executes applications for handling intelligent network (IN) services provided to the mobile communication devices 102 and 104.

The HLR 118 in one example stores profile information for users of the mobile communication devices 102 and 104. The profile information in one example comprises a flag that indicates (e.g., yes or no) if the mobile communication devices 102 and 104 support the dual-mode service. In a further example, the profile information comprises a plurality of flags or indicators for the services supported by the mobile communication devices 102 and 104. The flags or indicators may indicate services that are supported, channels that are supported, maximum range, dual-mode service subscription status, or other indicators, as will be appreciated by those skilled in the art. Alternatively, it is also possible for SAC 116 to maintain such information related to device profile and subscription status. The SMSC 122 in one example provides a short message service (SMS) to the mobile communication devices 102 and 104. Intelligent peripheral 124 in one example is configured to provide a prompt to a user of the mobile communication devices 102 and 104, as described herein.

The cellular service network 106 in one example comprises means for locating the mobile communication devices to which it provides cellular service, shown in FIG. 1 as the MLC 120. Where the cellular service network 106 comprises a CDMA network, the MLC 120 in one example comprises a position determining entity (PDE) and/or a mobile positioning center (MPC) of a CDMA network. Where the cellular service network 106 comprises a GSM network, the MLC 120 comprises a gateway mobile location center (GMLC) and/or a serving mobile location center (SMLC). The MLC 120 in one example determines a location of the mobile communication devices 102 and 104. In one example where the mobile communication devices 102 and 104 are GPS enabled, the MLC 120 communicates with the GPS network 108 to determine locations of the mobile communication devices 102 and 104. If the mobile communication devices 102 and 104 are not GPS enabled, the MLC 120 in another example employs a triangulation procedure to determine the location of the mobile communication devices 102 and 104. The location of the mobile communication devices 102 and 104 may be provided as latitude and longitude coordinates, grid coordinates, or other location parameters, as will be appreciated by those skilled in the art.

While only one cellular service network 106 is described and shown in FIG. 1, additional cellular service networks may be employed, for example, one cellular service network for each mobile communication device. The cellular service network 106 may also comprise additional components as needed to support a roaming mobile communication device, such as a home MSC, serving MSC, and visiting location register (VLR), as will be appreciated by those skilled in the art.

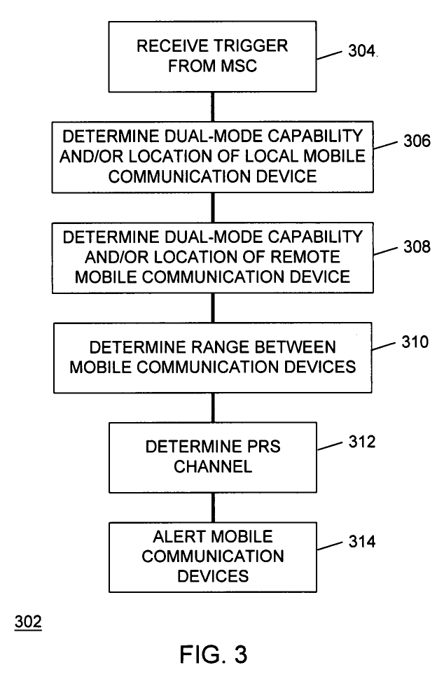

An illustrative description of operation of the apparatus 100 is presented, for explanatory purposes. Turning to FIG. 3, a logic flow 302 represents one implementation of steps performed by the SAC 116. In alternate implementations, the steps may be performed by other components within the cellular service network 106. A user of the mobile communication device 102 (e.g., “calling party”) attempts to establish a communication session with a user of the mobile communication device 104 (e.g., “called party”). In one example, the user employs a keypad to enter in a phone number for the mobile communication device 104. In alternative examples, the user may use a voice recognition system or preset hotkeys to initiate the communication session.

In one embodiment, the MSC 114 receives a call setup message from the mobile communication device 102. In response to the call setup message, the MSC 114 sends a call origination trigger to the SAC 116 (STEP 304). The SAC 116 in one example determines (STEP 306) if the mobile communication device 102 (e.g., a local mobile communication device served by the cellular service network 106) supports the dual-mode service. For example, the SAC 116 requests the dual-mode subscription status from the HLR 118, if the HLR 118 maintains this information. Alternatively, the SAC 116 may look up its internal database to determine this information. If the mobile communication device 102 does not support the dual-mode service, the SAC 116 sends a CONTINUE message to the MSC 114 to resume call delivery with the cellular service.

The SAC 116 determines (STEP 308) a location of the mobile communication device 104, for example, a remote mobile communication device. In a further example, the SAC 116 determines if the mobile communication device 104 supports the dual-mode service. In one example, the SAC 116 obtains the location and/or profile information of the mobile communication device 104 from a cellular service network, analogous to the cellular service network 106. For example, the SAC 116 obtains the location and/or profile information related to the dual-mode service from an MLC 120 and HLR 118, (if the HLR 118 maintains this information, or, alternatively, the SAC 116 may look up its internal database to determine profile information) respectively, of the cellular service network for the mobile communication device 104. In another example, the SAC 116 obtains the location of the mobile communication device 104 from the mobile communication device 104 itself if the mobile communication device 104 is GPS enabled. For example, the SAC 116 cooperates with the SMSC 122 to send a short message service (SMS) message to the mobile communication device 104 to obtain the location, such as GPS coordinates.

If the SAC 116 is unable to obtain the location, or if the mobile communication device 104 is unreachable, the SAC 116 instructs the MSC 114 to perform a standard call delivery for a cellular call. If the location of the mobile communication device 104 is determined, the SAC 116 determines the location of the mobile communication device 102. For example, the SAC 116 queries the MLC 120 to obtain the location. The SAC 116 determines (STEP 310) if a distance between the mobile communication devices 102 and 104 is within a coverage range of a PRS supported by both the mobile communication devices 102 and 104. If the distance is beyond the range of the PRS, the SAC 116 sends the CONTINUE message to the MSC 114 to perform the standard call delivery.

If the SAC 116 determines that the distance is within the range of the PRS, the SAC 116 provides an option to the user of the mobile communication device 102 to select either the cellular service or the PRS for the communication session. In one example, the SAC 116 signals the intelligent peripheral 124 to send an audio message to the mobile communication device 102. If the user of the mobile communication device 102 selects the PRS for the communication session, the cellular service network 106 aborts the call attempt.

Upon selection of the PRS for the communication session, the SAC 116 in one example informs the mobile communication device 104 to expect the communication session on the PRS. Communication over the PRS is through a specific PRS channel. FRS, GMRS, and MURS comprise 14, 23, and 5 available channels, respectively, as will be understood by those skilled in the art. Before the communication session can begin, the mobile communication devices 102 and 104 must be tuned to the same PRS channel. In one example, the PRS channel is predetermined before the mobile communication device 102 initiates the communication session. A predetermined PRS channel in one example is based on a mobile directory number for the mobile communication devices 102 and 104. For example, table 202 of FIG. 2 shows one implementation where the PRS channel is based on a last digit of the called party (e.g., mobile communication device 104) dialed number. The audio message from the IP 124 in one example indicates to the user of the mobile communication device 102 which PRS channel is appropriate, for example, “You can reach your called party via GMRS channel 16. To do so, please hang up and use this alternate mode.”. If the PRS channel is predetermined, the mobile communication device 104 may not need to be notified of the PRS channel. However, the mobile communication device 104 would still receive a notification that the PRS was selected for the communication session, as described above. This message is necessary for the device 104 to switch over to PRS mode in order to receive the call.

In another example, the PRS channel is dynamically selected (STEP 312) by the SAC 116 after the mobile communication device 102 initiates the communication session. For example, the PRS channel is based on one or more of: current usage of available PRS channels in the area surrounding the mobile communication devices 102 and 104, recent usage of the available PRS channels, or a random selection from the available PRS channels. If the PRS channel is dynamically selected, the SAC 116 in one example sends an SMS message to the mobile communication devices 102 and 104 to indicate (STEP 314) which channel to begin the communication session on.

In an alternate embodiment, the mobile communication devices 102 and 104 are configured to initiate the communication session. For example, the mobile communication device 102 intercepts the phone number dialed by the user of the mobile communication device 102. In one example, the mobile communication devices 102 and 104 comprise software applications that are executed to intercept the phone number and set up the PRS service. Prior to initiating the communication session over the cellular service, the mobile communication device 102 sends an SMS message to the mobile communication device 104 to request the location of the mobile communication device 104. In a further example, the mobile communication device 102 requests PRS capabilities of the mobile communication device 104. The requests for location and PRS capabilities may be in the same SMS message or in separate messages. The mobile communication device 104 responds with one or more SMS messages that comprise the location (if GPS enabled) and the PRS capabilities, if requested. Further, mobile communication device 104 can be set up by the user to selectively respond to such requests (e.g., via use of a “white list” or “allowed list” of calling party numbers) and thus stop any unwanted “location tracking” by snooping calling parties.

The mobile communication device 102 then determines the distance between the mobile communication devices 102 and 104. In this embodiment, the mobile communication devices 102 and 104 are GPS enabled and handle prompts, messages, and indications to the respective users. In addition, the cellular service networks for the mobile communication devices 102 and 104 need only support SMS. In another example, the mobile communication device 102 sends an SMS message with its location and PRS capabilities to the mobile communication device 104. In a further example, the SMS message also comprises a preselected PRS channel. The mobile communication device 104 then determines the distance between the mobile communication devices 102 and 104 and completes setup of the communication session.

Numerous alternative implementations of the present invention exist. In one embodiment, the MSC 114 comprises a home MSC (in a CDMA network) or a gateway MSC (in a GSM network) and sends a termination attempt trigger (for example, an Advanced Termination Trigger in a CDMA network), for a call terminated to the mobile communication device 104, to the SAC 116, instead of the origination attempt trigger.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The apparatus 100 in one example employs one or more computer-readable signal-bearing media. The computer-readable signal-bearing media store software, firmware and/or assembly language for performing one or more portions of one or more implementations of the invention. Examples of a computer-readable signal-bearing medium for the apparatus 100 comprise the recordable data storage medium 110 of the mobile communication devices 102 and 104, the base station 112, the MSC/SCP 114, the HLR 118, and the MLC 120. The computer-readable signal-bearing medium for the apparatus 100 in one example comprise one or more of a magnetic, electrical, optical, biological, and atomic data storage medium. For example, the computer-readable signal-bearing medium comprises floppy disks, magnetic tapes, CD-ROMs, DVD-ROMs, hard disk drives, and electronic memory.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a mobile communication device configured for communication through employment of a cellular service and a personal radio service (PRS).

2. The apparatus of claim 1, wherein the mobile communication device comprises a first mobile communication device that initiates a communication session with a second mobile communication device, wherein the second mobile communication device is configured for communication through the cellular service and the PRS;
wherein the first mobile communication device employs the cellular service or the PRS for the communication session based on a determination that a distance between the first mobile communication device and the second mobile communication device is within a coverage range of the PRS.

3. The apparatus of claim 2, further comprising:
a service application component of a cellular service network for the first mobile communication device that provides the cellular service to the first mobile communication device;
wherein the service application component is configured to make the determination upon receipt of an origination attempt trigger or termination attempt trigger.

4. The apparatus of claim 3, wherein the service application component is configured to obtain a location of the second mobile communication device from a mobile location center of a cellular service network for the second mobile communication device.

5. The apparatus of claim 3, wherein the service application component is configured to send an SMS message to the second mobile communication device to obtain a location of the second mobile communication device.

6. The apparatus of claim 3, wherein the service application component is configured to send a notification of the communication session over the PRS to the second mobile communication device.

7. The apparatus of claim 3, wherein the service application component is configured to select a channel for the communication session over the PRS;
wherein the service application component is configured to send a notification of the channel for the communication session over the PRS to the first and second mobile communication devices.

8. The apparatus of claim 3, further comprising:
an intelligent peripheral of the cellular service network for the first mobile communication device;
wherein the intelligent peripheral prompts a user of the first mobile communication device to select the cellular service or the PRS if the distance between the first mobile communication device and the second mobile communication device is within the coverage range of the PRS.

9. The apparatus of claim 2, wherein the first mobile communication device prompts a user of the first mobile communication device to select the cellular service or the PRS if the distance between the first mobile communication device and the second mobile communication device is within the coverage range of the PRS.

10. The apparatus of claim 2, wherein the first and second mobile communication devices are configured to initiate the communication session.

11. The apparatus of claim 10, wherein the first and second mobile communication devices exchange one or more short message service (SMS) messages to initiate the communication session.

12. The apparatus of claim 2, wherein the first and second mobile communication devices employ the PRS over a PRS channel for the communication session;
wherein the PRS channel for the communication session is predetermined before the first mobile communication device initiates the communication session.

13. The apparatus of claim 12, wherein the PRS channel is based on one or more of:
a mobile directory number of the first mobile communication device; and
a mobile directory number of the second mobile communication device.

14. The apparatus of claim 2, wherein the first and second mobile communication devices employ the PRS over a PRS channel for the communication session;
wherein the PRS channel for the communication session is dynamically selected after the first mobile communication device initiates the communication session.

15. The apparatus of claim 14, wherein the PRS channel is based on one or more of:
current usage of available PRS channels;
recent usage of the available PRS channels;
a random selection from the available PRS channels.

16. The apparatus of claim 1, wherein the mobile communication device is configured to automatically switch to the PRS when the cellular service is not available.

17. The apparatus of claim 1, wherein the cellular service comprises a code division multiple access (CDMA) service or a global system for mobile communications (GSM) service.

18. The apparatus of claim 1, wherein the PRS comprises a family radio service (FRS), a general mobile radio service (GMRS), a citizens band radio service (CB), a multi-use radio service (MURS), a private/professional mobile radio service (PMR), or a public access mobile radio service (PAMR).

19. A method, comprising the steps of:
receiving a request for a communication session between a first mobile communication device and a second mobile communication device;
making a determination of a distance between the first mobile communication device and the second mobile communication device; and
selecting between a personal radio service (PRS) and a cellular service for the communication session based on the determination of the distance between the first mobile communication device and the second mobile communication device.

20. The method of claim 19, wherein the step of making the determination of the distance between the first mobile communication device and the second mobile communication device comprises the steps of:
obtaining a location of the first mobile communication device from one of the first mobile communication device and a cellular service network of the first mobile communication device; and
obtaining a location of the second mobile communication device from one of the second mobile communication device and a cellular service network of the second mobile communication device.

21. The method of claim 20, wherein the step of obtaining the location of the second mobile communication device from one of the second mobile communication device and the cellular service network of the second mobile communication device comprises the step of:
sending a short message service (SMS) message to the second mobile communication device to request the location of the second mobile communication device.

22. The method of claim 19, wherein the step of selecting between the PRS and the cellular service for the communication session comprises the step of:
prompting a user of the first mobile communication device for a selection of the PRS or the cellular service.

23. The method of claim 19, further comprising the step of:
selecting a PRS channel for the communication session upon a selection of the PRS for the communication session.

24. The method of claim 23, wherein the step of selecting the PRS channel for the communication session upon the selection of the PRS for the communication session comprises the step of:
selecting the PRS channel based on one or more of:
a mobile directory number of the first mobile communication device; and
a mobile directory number of the second mobile communication device.

25. The method of claim 23, wherein the step of selecting the PRS channel for the communication session upon the selection of the PRS for the communication session comprises the steps of:
selecting the PRS channel from a set of available PRS channels based on one or more of:
current usage of the set of available PRS channels;
recent usage of the set of available PRS channels;
a random selection from the available PRS channels; and
indicating the PRS channel to the first mobile communication device and the second mobile communication device.

26. The method of claim 19, further comprising the step of:
switching automatically from the cellular service to the PRS when the cellular service is not available.
